(19) United States
(12) Patent Application Publication
(10) Pub. No.: US 2002/0019244 A1
(43) Pub. Date: Feb. 14, 2002

(54) Wide area information network with mobile nodes

(76) Inventors: Eric K. Bradley, Columbus, IN (US); William A. Gatliff, Metamora, IL (US); William A. Monette, Columbus, IN (US)

Correspondence Address: C. John Brannon, Woodard, Emhardt, Naughton, Moriarty and McNett, Bank One Center/Tower, 111 Monument Circle, Suite 3700, Indianapolis, IN, 46204-5137, US

(21) Appl. No.: 09/826,281

(22) Filed: Apr. 4, 2001

Related U.S. Application Data
(63) Continuation-in-part of application No. 09/383,727, filed on Aug. 26, 1999.

(51) Int. Cl. H04B 7/00

(52) U.S. Cl. 455/517; 455/426

(57) ABSTRACT

? train The present invention relates to a system whereby a vehicle, such as a truck in a fleet, can communicate via a widely distributed, low-cost network to the fleet operator, who is located at a distant, fixed location. The network system is relatively low cost, easily accessed by a multitude of vehicles and fleet operators, and is robust in communicating the data. The system comprises one or more fixed nodes which have the ability to communicate at any time with a routing host server. The routing host is in turn connected to one or more mobile hosts via a communications link which also may be accessed at any time. Mobile nodes, such as vehicles moving about, are able to communicate with each of the mobile hosts whenever the mobile node is in the geographic vicinity of the mobile host, such as by two-way radio communication. When a mobile node makes communication contact with a mobile host, this information is relayed to the routing host. Once the routing host is aware that a connection has been made with a mobile node, the routing host can direct communications from any fixed node to the connected mobile node, and from the connected mobile node to any of the fixed nodes. In a preferred embodiment, the mobile hosts are placed where large concentrations of vehicles would be expected, such as truck stops, rest stops, weigh stations, loading terminals, etc.

### CROSS-REFERENCE TO RELATED APPLICATION

This patent application is a continuation-in-part of U.S. patent application Ser. No. 09/383,727, filed Aug. 26, 1999.

### TECHNICAL FIELD OF THE INVENTION

The present invention generally relates to networks for the transfer of information and, more particularly, to a wide area information network with mobile nodes.

### BACKGROUND OF THE INVENTION

Companies involved in the transportation industry often desire to establish two-way communications with the transportation vehicles and the personnel involved in operating the vehicles. It is usually necessary for at least periodic two-way communication links to be established between the transportation company and the operator of the vehicle. Furthermore, modern vehicles contain technology which collects large amounts of data about the vehicle and its operation. This information is proving to be more and more useful in the deployment of such vehicles to maximize profitability of the transportation company operating the vehicle.

In order to establish communications with the vehicle driver and with the vehicle itself, connection of a mobile vehicle to a fixed information network has proven to be relatively difficult and relatively costly, with severe constraints placed on data types and data bandwidth. Currently, the most pervasive technology used for such applications is the cellular telephone network for local area connections and satellite transmissions for wide area connections. Such connections are optimized for voice communications with the drivers within the vehicle. Using such methods for communicating data garnered from the vehicle itself (such as data coming from the engine control electronics) via these networks is unattractive, essentially because of the cost involved.

Data gathered by vehicle on-board electronics is characterized as needing to be transmitted for short periods of time and at “convenient” times. Convenience in this case would be whenever it is possible to establish communications with the vehicle such that a relatively large amount of stored data may be downloaded from the vehicle and any command messages to the vehicle may also be sent at this time. Certainly, such data can be transmitted via satellite or cellular modem to and from the transportation company home office; however, this is costly since the mobile nature of the vehicle requires the installation of a number of cellular transceivers or the launching of at least one satellite in order to achieve wide area connectivity.

There is therefore a need for a wide area information network which would allow for relatively inexpensive voice and data communications between a mobile vehicle and one or more remotely located sites, such as transportation company offices. The present invention is directed toward meeting this need.

### SUMMARY OF THE INVENTION

The present invention relates to a system whereby a vehicle, such as a truck in a fleet, can communicate via a widely distributed, low-cost network to the fleet operator, who is located at a distant, fixed location. The network system is relatively low cost, easily accessed by a multitude of vehicles and fleet operators, and is robust in communicating the data. The system comprises one or more fixed nodes which have the ability to communicate at any time with a routing host server. The routing host is in turn connected to one or more mobile hosts via a communications link which also may be accessed at any time. Mobile nodes, such as vehicles moving about, are able to communicate with each of the mobile hosts whenever the mobile node is in the geographic vicinity of the mobile host, such as by two-way radio communication. When a mobile node makes communication contact with a mobile host, this information is relayed to the routing host. Once the routing host is aware that a connection has been made with a mobile node, the routing host can direct communications from any fixed node to the connected mobile node, and from the connected mobile node to any of the fixed nodes. In a preferred embodiment, the mobile hosts are placed where large concentrations of vehicles would be expected, such as truck stops, rest stops, weigh stations, loading terminals, etc.

In one form of the invention, a wide area information network is disclosed, comprising at least one fixed node; a routing host coupled to each fixed node for two-way communication therebetween; at least one mobile host, wherein each mobile host is coupled to the routing host for two-way communication therebetween; and at least one mobile node, wherein each mobile node is operative to establish two-way communications with one of the mobile hosts whenever the mobile node is within a predetermined range of said one mobile host; wherein two-way communications may be established between any fixed node and any mobile node when the mobile node has established communication with one of the mobile hosts.

In another form of the invention, a wide area information network is disclosed, comprising at least one fixed node at a fixed company office location; a routing host coupled to each fixed node for two-way communication therebetween; at least one mobile host at a fixed location frequented by vehicles, wherein each mobile host is coupled to the routing host for two-way communication therebetween; and at least one mobile node comprising a vehicle, wherein each mobile node is operative to establish two-way communications with one of the mobile hosts whenever the mobile node is within a predetermined range of said one mobile host; wherein two-way communications may be established between any fixed node and any mobile node when the mobile node has established communication with one of the mobile hosts.

### BRIEF DESCRIPTION OF THE DRAWINGS

FIG. 1 is a schematic block diagram of a preferred embodiment wide area network of the present invention.

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

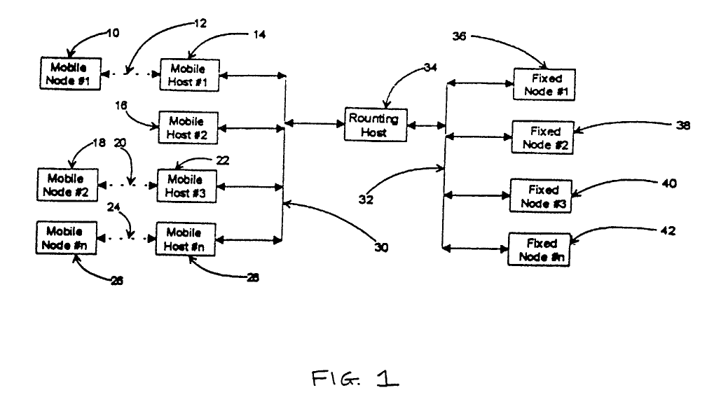

Referring to FIG. 1, a mobile node 10 is shown, which has the ability to move within a defined geographic region. Also shown in FIG. 1 is a mobile host 14, which likewise has the ability to move but may alternately remain fixed at a particular location. Whenever the mobile node 10 moves within a predetermined distance of the mobile host 14, a communications link 12 may be established therebetween by any convenient means, such as by two-way radio communications. As long as the mobile node 10 remains within the predetermined radius of the mobile host 14, communications from the mobile host 14 to the mobile node 10, and vice versa, may be maintained.

Similarly, other mobile nodes, such as the mobile nodes 18 and 26, move independently within the geographic region. Other mobile hosts 16, 22 and 28 also move independently within the geographic region. Any time one of the mobile nodes comes within a predetermined radius of one of the mobile hosts, a communications link is established. As shown in FIG. 1, the mobile node 18 has established a communications link 20 with a mobile host 22, the mobile node 26 has established a communications link 24 with the mobile host 28, while the mobile host 16 does not have a communications link established with it because none of the mobile nodes are within the required predetermined radius. Additionally, if one of the mobile nodes, such as the mobile node 18, were to move out of the predetermined radius surrounding mobile host 22 and into the predetermined radius surrounding mobile host 16, the communications link 20 would be broken with mobile host 22 and a new communications link would be established with another mobile host, such as mobile host 16.

All of the mobile hosts are coupled to a routing host 34 by means of communication lines 30, portions of which are preferably of a permanent nature, such as telephone lines, and portions of which are preferably of a broadcast or transient nature, such as radios, mobile telephones, cellular telephones, radio modems, or the like. Because of the connection between the mobile hosts and the routing host provided by the communication lines 30, the routing host 34 is always aware of which mobile nodes have established communications links with which mobile hosts. In other words, the routing host 34 keeps track of the locations of the mobile nodes and the mobile hosts and maintains an efficient flow of information therebetween.

The routing host 34 is further in communication with a plurality of fixed nodes 36, 38, 40 and 42, by means of the communications lines 32. The fixed nodes represent fixed locations which have a need to communicate at various times with the mobile nodes. In a preferred embodiment, the communications lines 32 represent telephone lines, such as connection through a worldwide computer network, such as the Internet.

It can be seen, with reference to FIG. 1, that the routing host 34 may act as a message clearinghouse, routing messages received from time to time from the fixed nodes 36, 38, 40 and 42 to the mobile hosts whenever the mobile hosts indicate that they have achieved communications connection with one of the mobile nodes. Similarly, any of the mobile nodes may communicate through the routing host 34 to any of the fixed nodes once they have established communications with one of the mobile hosts. It is therefore possible for fixed node 36 to inform the routing host 34 of a message that it wishes to transmit to mobile node 10. The routing host 34 will then wait until one of the mobile hosts indicates that it has achieved a communications connection with the mobile node 10, such as the communications connection 12 made with mobile host 14 in FIG. 1. Once the communications link 12 has been established, the routing host 34 will relay the message from fixed node 36 to the mobile node 10 through mobile host 14 and communications link 12. Network connections to the mobile hosts can be any sort of link that will host bi-directional communications, such as hardwired direct connections, radio link connections, satellite connections, cellular telephone connections, etc. Each mobile node, mobile host, routing host and fixed node may comprise a programmable computer and associated communications equipment. For example, each mobile node 10 may represent an electronic engine control computer on a truck. Each mobile host, routing host and fixed node may represent a personal computer and a modem.

In an application of the preferred embodiment of FIG. 1 in the trucking industry, each of the mobile nodes would represent trucks with onboard computers (OBC) that collect information critical to the efficient operation of the vehicle. Each of the mobile hosts would also represent trucks with transceiver-equipped OBCs sufficiently powerful to communicate with each of these trucks. Preferably, there are enough mobile hosts in circulation to constitute a mobile host network such that a mobile node will always likely be able to connect thereto. As each truck connects and disconnects from the network as they pass through the geographic proximity of at least one mobile host, a communications connection between the truck and the home office (i.e. one of the fixed nodes) could be made. As connections are made between a mobile node and one of the mobile hosts, the mobile host informs the routing host 34 of the connection. For example, the mobile hosts can be connected to the routing host via the Internet. The routing host 34 would in turn be connected to the fixed host at the trucking company, also by the Internet, for example. Messages from the trucking company office (one of the fixed nodes) to their respective trucks (the mobile nodes) are first temporarily routed to the routing host 34 and stored until a connection to one of the mobile hosts is noted. The routing host 34 would then transmit the information to the truck via the appropriate mobile host.

The routing host 34 reduces the network load since a message from the fixed node does not need to be routed to all of the mobile hosts for possible delivery, when only one mobile host at any one time will establish communication with the designated mobile node. The routing host 34 can therefore be used to concentrate the messages until delivery is possible. Furthermore, the system can be shared by a multitude of different trucking companies, each company representing one of the fixed nodes. Because each mobile node will identify itself to the mobile host when communication has been established, the mobile nodes can represent trucks from many different companies which are part of the system, thereby allowing the communications of several different companies to take place on the same network.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed:

1. A wide area information network, comprising:
at least one fixed node;
a routing host coupled to each fixed node for two-way communication therebetween;
at least one mobile host, wherein each mobile host occupies an unfixed location and is coupled to the routing host for two-way communication therebetween; and
at least one mobile node, wherein each mobile node is operative to establish two-way communications with one of the mobile hosts whenever the mobile node is within a predetermined range of said one mobile host;
wherein two-way communications may be established between any fixed node and any mobile node when the mobile node has established communication with one of the mobile hosts.

2. The wide area information network of claim 1, wherein each mobile host is operative to notify the routing host when the mobile host has established communication with a mobile node.

3. The wide area information network of claim 1, wherein the routing host is operative to store a message from the fixed node to the mobile node until communication is established between the mobile node and the mobile host.

4. The wide area information network of claim 1, wherein the predetermined range comprises a range for establishing radio communication between the mobile node and said one mobile host.

5. The wide area information network of claim 1, wherein the mobile host comprises a vehicle on-board computer.

6. The wide area information network of claim 1, wherein the mobile node comprises a vehicle on-board computer.

7. The wide area information network of claim 1, wherein the routing host comprises a personal computer and modem.

8. The wide area information network of claim 1, wherein the fixed node comprises a personal computer and modem.

9. The wide area information network of claim 1, wherein each fixed node is coupled to the routing host by a global computer network.

10. The wide area information network of claim 1, wherein each mobile host is coupled to the routing host by a global computer network.

11. A wide area information network, comprising:
at least one fixed node at a fixed company office location; a routing host coupled to each fixed node for two-way communication therebetween;
at least one mobile host comprising a vehicle, wherein each mobile host is coupled to the routing host for two-way communication therebetween; and
at least one mobile node comprising a vehicle, wherein each mobile node is operative to establish two-way communications with one of the mobile hosts whenever the mobile node is within a predetermined range of said one mobile host;
wherein two-way communications may be established between any fixed node and any mobile node when the mobile node has established communication with one of the mobile hosts.

12. The wide area information network of claim 11, wherein each mobile host is operative to notify the routing host when the mobile host has established communication with a mobile node.

13. The wide area information network of claim 11, wherein the routing host is operative to store a message from the fixed node to the mobile node until communication is established between the mobile node and the mobile host.

14. The wide area information network of claim 11, wherein the predetermined range comprises a range for establishing radio communication between the mobile node and said one mobile host.

15. The wide area information network of claim 11, wherein the mobile node comprises a vehicle on-board computer.

16. The wide area information network of claim 11, wherein the routing host comprises a personal computer and modem.

17. The wide area information network of claim 11, wherein the fixed node comprises a personal computer and modem.

18. The wide area information network of claim 11, wherein each fixed node is coupled to the routing host by a global computer network.

19. The wide area information network of claim 11, wherein each mobile host is coupled to the routing host by a global computer network.
